(19) United States
(12) Patent Application Publication
(10) Pub. No.: US 2025/0214554 A1
(43) Pub. Date: Jul. 3, 2025

(54) METHOD OF CONTROLLING A BRAKING SYSTEM AND RELATED BRAKING SYSTEM

(71) Applicant: BREMBO S.p.A., Curno (Bergamo) (IT)

(72) Inventors: Alfonso TARANTINI, Curno (Bergamo) (IT); Eugenio BONALUMI, Curno (Bergamo) (IT)

(73) Assignee: BREMBO S.p.A., Curno (Bergamo) (IT)

(21) Appl. No.: 18/850,112

(22) PCT Filed: Mar. 24, 2023
(86) PCT No.: PCT/IB2023/052902

§ 371 Date: Sep. 24, 2024

(30) Foreign Application Priority Data
Mar. 25, 2022 (IT) 102022000005954

(51) Int. Cl. B60T 13/74; B60T 8/171; B60T 8/172

(52) U.S. Cl. CPC B60T 13/741; B60T 8/171; B60T 8/172; B60T 2270/89

(57) ABSTRACT

A method of controlling a braking system of a vehicle for deactivating a parking-braking force actuated by the braking system is provided. The method involves actuating, by an electronic processing unit, a first actuator of a first brake caliper so as to release a first braking force and reduce a value of the first braking force, detecting the value of the first braking force during actuation of the first actuator by detection means, in the instant in which it is detected that the first braking force is reduced to a value substantially equal to zero, stopping the first actuator and actuating a second actuator of a second brake caliper, by the electronic processing unit, so as to release a second braking force and reduce a value of the second braking force, and reducing the value of the second braking force to a value substantially equal to zero.

### DESCRIPTION

### Field of the Invention

The present invention relates to a method of controlling a braking system, in particular of a vehicle, and to a braking system of a vehicle.

### Background Art

Motorcars and in general vehicles with more than two wheels intended to transport passengers on roads, are provided with a hand parking brake, the function of which is to lock the wheels of the vehicle thus preventing the movement thereof when it is parked.

In modern braking systems, e.g., those provided with electronic Brake-By-Wire (BBW) technology, the hand parking brake is replaced by an Electric Parking Brake (EPB).

For all intents and purposes, the EPB electric parking brake can be considered a sub-system of an electronic braking system with BBW technology which is used for service braking.

In greater detail, using the EPB subsystem, the driver can activate the wheel-locking mechanism by means of an actuating device, such as an appropriate button or other automatic functions managed by an electronic processing unit, such as signal logics related to the ignition key, the gear engagement, and the accelerator pedal that, once activated, sends a request for parking-braking activation to an electronic control unit of the vehicle, which electrically actuates the brake pads to lock the brake discs and therefore the movement of the vehicle.

Vice versa, when restarting, the driver can deactivate the wheel locking mechanism by means of an actuating device that, once activated, sends a parking-braking deactivation request to an electronic control unit of the vehicle, which electrically actuates the brake pads to unlock the brake discs and therefore the movement of the vehicle.

Moreover, in addition to replacing the parking-braking function traditionally performed by the hand parking brake, the EPB subsystem is configured to provide automatic supporting functions to the driver, including the so-called “AutoHold” function, i.e., the function allowing the wheels to be locked automatically and without the driver's request when the vehicle is stationary, e.g., uphill, and to be released as soon as the driver presses the accelerator pedal of the vehicle.

The need is felt to minimize the time interval which elapses from the instant in which the deactivation of the parking braking is required to the instant in which the vehicle is ready to restart.

Such a time interval thus elapses from the moment in which the electronic control unit of the vehicle is requested to release the braking force by completely opening the parking brake until there is no longer any residual braking torque acting on the at least two brake discs of the vehicle, caused by the contact with the pads.

The absence of braking force acting on the brake discs can be determinable by a position sensor which monitors, either directly or indirectly, the position of the pads with respect to the respective brake disc, or by a current sensor configured to detect, either directly or indirectly, the force actuated by the pads on the respective brake disc.

In braking systems comprising at least two brake calipers, either fixed or floating, each fixed or floating brake caliper is associated with a respective wheel of the vehicle and comprises at least one pad facing a brake disc. The at least one pad is actuatable either towards or away from the brake disc by actuating at least one actuator.

The respective actuators of the at least two brake calipers in the braking system are controlled by the electronic control unit.

The respective actuators of the at least two brake calipers can be controlled either in parallel or in a selective manner. If the actuators cannot be controlled in parallel, i.e., at the same time, due to energy or structural constraints, the respective actuators of the at least two brake calipers are controlled in a selective manner, i.e., in sequence. According to the latter control logic, the electronic control unit is configured to control the actuation, and the consequent movement, of the one or more actuators of only one brake caliper at a time.

For each of the two brake calipers, the step of releasing the parking braking can be divided into three successive steps, namely:
an inrush step Ph1, which elapses from the instant in which the electronic control unit commands the at least one actuator of the respective brake caliper to move, to the instant in which the at least one actuator starts to move, and in which the braking force acting on the brake disc remains constant;
a force release step Ph2, which elapses from the instant in which the force actuated by the at least one actuator on the brake disc begins to reduce up to zero;
a separating step Ph3, in which the at least one actuator continues to move so as to ensure a safe separation between the pad and the brake disc, so as to ensure no residual braking force, where the third step Ph3 elapses from the instant in which the force actuated by the at least one actuator is reduced to zero, to the instant in which the at least one actuator completes the safe separation.

In the known control logics, the electronic control unit is configured to actuate the complete release of the parking braking by commanding the first of the at least two brake calipers to perform the steps Ph1, Ph2, and Ph3, and then commanding the second of the at least two brake calipers to perform the steps Ph1, Ph2, and Ph3.

### Solution

It is the object of the present invention to provide a method of controlling a braking system and a braking system such as to obviate at least some of the drawbacks of the prior art.

It is a particular object of the present invention to provide a method of controlling a braking system and a braking system such as to minimize the time interval which elapses from the instant in which the deactivation of the parking braking is required to the instant in which the vehicle is ready to restart, i.e., in which the braking force acting on the brake disc is reduced to zero.

It is a further object of the present invention to provide a control method, and a braking system configured to perform the control method, simplified and such as to have fewer energy and structural constraints.

These and other objects are achieved by a method of controlling a braking system and a braking system according to the independent claims.

The dependent claims relate to preferred and advantageous embodiments of the present invention.

### DRAWINGS

In order to better understand the invention and appreciate the advantages thereof, some non-limiting exemplary embodiments thereof will be described below with reference to the accompanying drawings, in which:

FIG. 1 diagrammatically 1 shows a braking system, according to an embodiment of the invention;

FIG. 2 is a diagram showing the force actuated by a brake caliper of a braking system, according to an embodiment of the invention;

FIG. 3 is a diagram showing the force actuated by the at least two brake calipers of a braking system, according to the prior art;

FIG. 4 is a diagram showing the force actuated by the at least two brake calipers of a braking system, according to an embodiment of the invention.

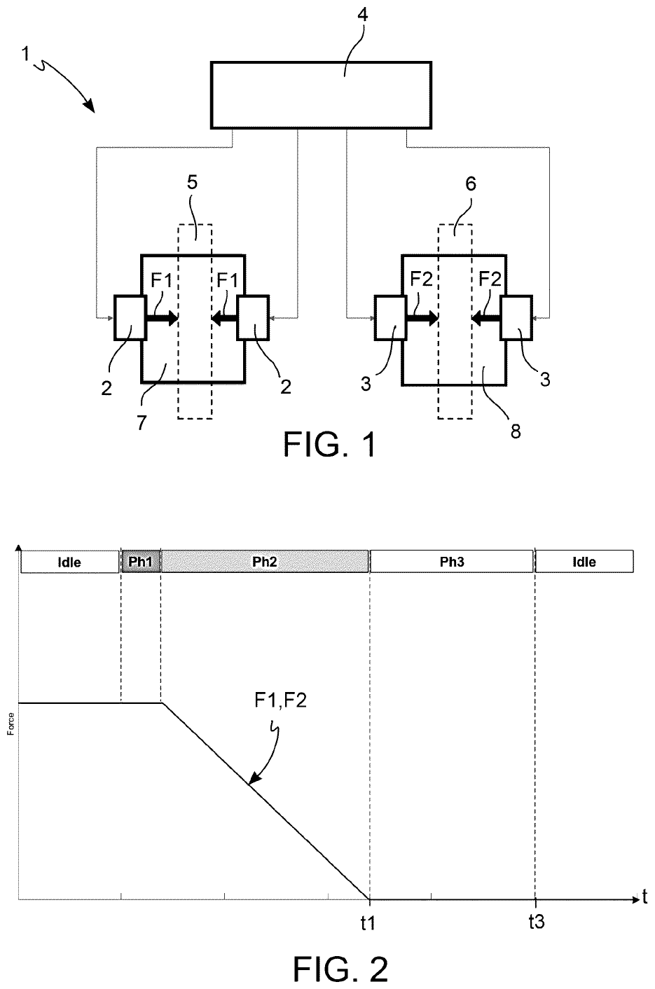

### DESCRIPTION OF SOME PREFERRED EMBODIMENTS

A method of controlling a braking system 1 of a vehicle for deactivating a parking-braking force actuated by the braking system 1 is described below with reference to the figures.

The braking system 1 is of the type comprising at least one first brake caliper 7 and one second brake caliper 8. The first brake caliper 7 is associable with one wheel of the vehicle, while the second brake caliper 8 is associable with a further wheel of the vehicle.

The first brake caliper 7 comprises:
a first brake disc 5;
at least one first pad facing the first brake disc 5;
at least one first actuator 2, configured to apply and release a first braking force F1 on the at least one first pad, so as to move the at least one first pad from an open position, in which the at least one first pad is positioned at a maximum distance from the first brake disc 5 and does not actuate a parking-braking force, to a closed position in which the at least one first pad is biased against the first brake disc 5 and actuates a parking-braking force, and vice versa.

The second brake caliper 8 comprises:
a second brake disc 6;
at least one second pad facing the second brake disc;
at least one second actuator 3, configured to apply and release a second braking force F2 on the at least one second pad so as to move the at least one second pad from an open position, in which the at least one second pad is positioned at a maximum distance from the second brake disc 6 and does not actuate a braking force, to a closed position in which the at least one second pad is biased against the second brake disc 6 and actuates a parking-braking force, and vice versa.

The braking system 1 is of the type further comprising:
an electronic processing unit 4, configured to control the actuation of the at least one first actuator 2 and the at least one second actuator 3;
detection means, operatively connected to the electronic processing unit 4, configured to detect, either directly or indirectly, the value of the first braking force F1 actuated by the at least one first actuator 2 on the at least one first pad, and to detect, either directly or indirectly, the value of the second braking force F2 actuated by the at least one second actuator 3 on the at least one second pad.

The method comprises the steps of:
actuating, by means of the electronic processing unit 4, the at least one first actuator 2 so as to release the first braking force F1 and reduce the value of the first braking force F1;
detecting the value of the first braking force F1 during the actuation of the at least one first actuator 2 and by the detection means;
in the first instant of time t1 in which it is detected that the first braking force F1 is reduced to a value substantially equal to zero, stopping the at least one first actuator 2 and actuating the at least one second actuator 3, by means of the electronic processing unit 4, so as to release the second braking force F2 and reduce the value of the second braking force F2;
reducing the value of the second braking force F2 to a value substantially equal to zero.

Advantageously, the control method according to the present invention minimizes the time interval which elapses from the instant in which the parking-braking deactivation is required to a zero force time instant to in which the vehicle is ready to restart, i.e., when the braking force acting on both the first and second brake discs is reduced to zero.

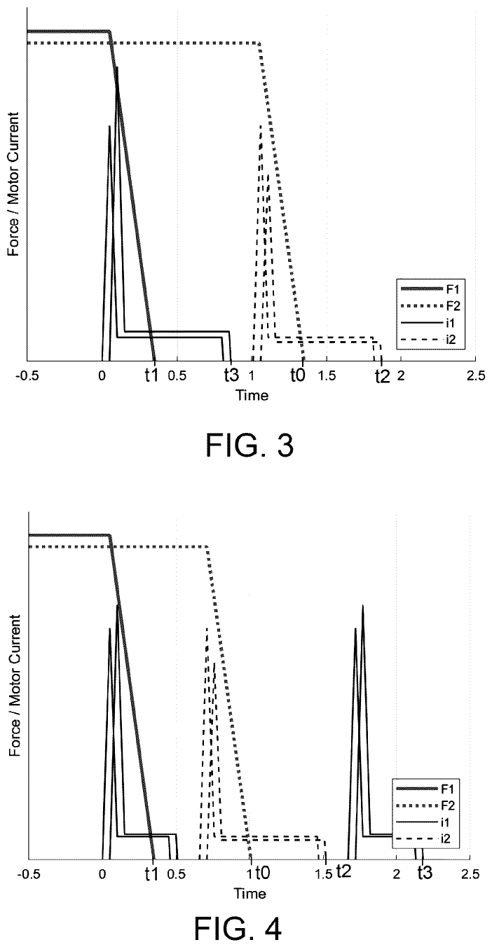

Indeed, as can be seen by comparing FIG. 4, showing a control method according to the present invention, and FIG. 3, showing the control method according to the prior art, the method according to the present invention reduces the time required to cancel the braking force acting on both brake discs, i.e., minimizes the time required for achieving the condition in which, in the zero force time instant to, the force actuated by the first and second brake calipers 7, 8 on the respective first and second brake discs 5, 6 is substantially equal to zero, and the vehicle is ready to restart.

Advantageously, the first brake caliper 7 and the second brake caliper 8 are fixed or floating brake calipers.

Preferably, the first and second brake calipers 8 are associable with either the front wheel pair or the rear wheel pair of a vehicle, respectively.

Advantageously, the method according to the present description is applicable to braking systems comprising a first and a second brake caliper, where both the first and second brake calipers comprise two pads positioned to be opposite to a brake disc, where the two opposite pads of each brake caliper are actuatable against the brake disc by at least one actuator, preferably by two respective actuators. Therefore, in the present description, the terms “first pad” and “second pad” are also to be understood as “first pair of opposite pads” and “second pair of opposite pads”. Similarly, “at least one first actuator” also means the one or more actuators acting on the first pair of pads, and “at least one second actuator” also means the one or more actuators acting on the second pair of pads. Similarly, “first braking force F1” and “second braking force F2” also mean the force applied to the first pair of opposite pads of the first brake caliper 7 and the force applied to the second pair of opposite pads of the second brake caliper 8.

According to an embodiment, the method comprises after the step of stopping the at least one first actuator 2 and actuating the at least one second actuator 3, by means of the electronic processing unit 4, so as to release the second braking force F2 and reduce the value of the second braking force F2, the steps of:
detecting the value of the second braking force F2 during the actuation of the at least one second actuator 3 and by the detection means;
in the instant in which it is detected that the second braking force F2 is reduced to a value substantially equal to zero, continuing the actuation of the at least one second actuator 3, preferably without any temporary stop of the at least one second actuator 3, so as to separate the at least one second pad from the second brake disc 6 and move the at least one second pad towards the open position;
detecting the position of the at least one second pad, either directly or indirectly, during the actuation of the at least one second pad and by the detection means;
in the second instant of time t2 in which it is detected that the at least one second pad is substantially positioned in the open position, stopping the at least one second actuator 3 and actuating the at least one first actuator 2, by means of the electronic processing unit 4, so as to separate the at least one first pad from the first brake disc 5 and move the at least one first pad towards the open position.

Optionally, the method comprises the following steps of:
detecting the position of the at least one first pad, either directly or indirectly, during the actuation of the at least one first pad and by the detection means;
in the third time instant t3 in which it is detected that the at least one first pad is substantially positioned in the open position, stopping the at least one first actuator 2.

According to an alternative embodiment, the method comprises, after the step of stopping the at least one first actuator 2 and actuating the at least one second actuator 3, by means of the electronic processing unit 4, so as to release the second braking force F2 and reduce the value of the second braking force F2, the steps of:
detecting the value of the second braking force F2 during the actuation of the at least one second pad and by the detection means;
in the instant in which it is detected that the second braking force F2 is reduced to a value substantially equal to zero, stopping the actuation of the at least one second actuator 3 and actuating the at least one first actuator 2, by means of the electronic processing unit 4, so as to separate the at least one first pad from the first brake disc 5 and move the at least one first pad towards the open position;
detecting the position of the at least one first pad, either directly or indirectly, during the actuation of the at least one first pad and by the detection means;
in the instant in which it is detected that the at least one first pad is substantially positioned in the open position, stopping the at least one first actuator 2 and actuating the at least one second actuator 3, by means of the electronic processing unit 4, so as to separate the at least one second pad from the second brake disc 6 and move the at least one second pad towards the open position;

Optionally, the method comprises the following steps of:
detecting the position of the at least one second pad,
either directly or indirectly, during the actuation of the at least one second pad and by the detection means;
in the instant in which it is detected that the at least one second pad is substantially positioned in the open position, stopping the at least one second actuator 3.

According to an embodiment, the step of detecting, by the detection means, the value of the first braking force F1 comprises the following steps:
detecting, by the detection means, the angular position of the at least one first actuator 2; and
calculating, by means of the electronic processing unit 4, the value of the first braking force F1 based on the angular position of the at least one first actuator 2.

Alternatively, the step of detecting, by the detection means, the value of the second braking force F1 comprises the following steps:
detecting the value of a first supply current i1 supplying the at least one first actuator 2; and
calculating, by means of the electronic processing unit 4, the value of the first braking force F1 based on the value of the first supply current i1 supplying the at least one first actuator 2.

According to an embodiment, in which the step of detecting, by the detection means, the value of the second braking F2 comprises the following steps:
detecting, by the detection means, the angular position of the at least one second actuator 3; and
calculating, by means of the electronic processing unit 4, the value of the second braking force F1 based on the angular position of the at least one second actuator 3.

Alternatively, the step of detecting, by the detection means, the value of the second braking force F2 comprises the following steps:
detecting the value of a second supply current i2 supplying the at least one second actuator 3; and
calculating, by means of the electronic processing unit 4, the value of the second braking force F1 based on the value of the second supply current i2 supplying the at least one second actuator 3.

According to an embodiment, the step of either directly or indirectly detecting the position of the at least one second pad by the detection means comprises:
detecting the elapsing of a predetermined time interval, starting from the instant in which it is detected that the second braking force F2 is reduced to a value substantially equal to zero and by the detection means;
associating the positioning of the at least one second pad in the open position at the end of the predetermined time interval and by means of the electronic processing unit 4.

Alternatively, the step of either directly or indirectly detecting the position of the at least one second pad by the detection means comprises:
detecting, by the detection means, the angular position of the at least one second actuator 3;
associating, by means of the electronic processing unit 4, the positioning of the at least one second pad in the open position with a predetermined angular position of the at least one second actuator 3.

According to an embodiment, the step of either directly or indirectly detecting the position of the at least one first pad during the actuation of the first pad and by the detection means, comprises:
detecting the elapsing of a predetermined time interval, starting from the instant in which the at least one second actuator 3 is stopped and by the detection means;
associating the positioning of the at least one first pad in the open position at the end of the predetermined time interval and by means of the electronic processing unit 4.

Alternatively, the step of detecting the position of the at least one first pad, either directly or indirectly, during the actuation of the at least one first pad and by the detection means comprises:
detecting, by the detection means, the angular position of the at least one first actuator 2;
associating, by means of the electronic processing unit 4, the positioning of the at least one first pad in the open position with a predetermined angular position of the at least one first actuator 2.

According to an embodiment, the step of actuating, by means of the electronic processing unit 4, the at least one first actuator 2 so as to release the first braking force F1 and reducing the value of the first braking force F1, is actuated upon the reception of a parking-braking force deactivation request signal by the electronic processing unit 4.

Furthermore, the parking-braking force deactivation request signal is sent by an actuating device operatively connected to the electronic processing unit 4, upon actuation of said actuating device.

The actuating device is actuatable by a user.

According to an embodiment, the method comprises, after the step of stopping the at least one first actuator 2 in the instant in which it is detected that the at least one first pad is substantially positioned in the open position, the step of:
sending, from the electronic processing unit 4 to a signaling device operatively connected to the electronic processing unit 4, a parking-braking force deactivation signal.

Furthermore, the parking-braking force deactivation signal is optionally viewable by a user by means of the signaling device.

According to an embodiment, the previously described method is applicable to a braking system 1 of the type comprising a first brake caliper 7 and a second brake caliper 8, in which the first brake caliper 7 comprises:
a pair of first pads positioned to be opposite to the first brake disc 5;
at least one pair of first actuators 2, configured to apply and release a first braking force F1 on the pair of first pads, so as to move the pair of first pads from an open position, in which both first pads are positioned at a maximum distance from the first brake disc 5 and do not actuate a parking-braking force, to a closed position, in which both first pads are biased against the first brake disc 5 and actuate a parking-braking force, and vice versa; and where said second brake caliper 8 comprises:
a pair of second pads positioned to be opposite to the second brake disc 6;
at least one pair of second actuators 3, configured to apply and release a second braking force F2 on the pair of second pads, so as to move the pair of second pads from an open position, in which both second pads are positioned at a maximum distance from the second brake disc 6 and do not actuate a parking-braking force, to a closed position, in which both second pads are biased against the second brake disc 6 and actuate a parking-braking force, and vice versa.

According to a further aspect of the invention, a braking system 1 of a vehicle is configured to activate and deactivate a parking-braking force.

The braking system 1 comprises at least one first brake caliper 7 and one second brake caliper 8. The first brake caliper 7 is associable with one wheel of the vehicle, while the second brake caliper 8 is associable with a further wheel of the vehicle.

The first brake caliper 7 comprises:
a first brake disc 5;
at least one first pad facing the first brake disc 5;
at least one first actuator 2, configured to apply and release a first braking force F1 on the at least one first pad, so as to move the at least one first pad from an open position, in which the at least one first pad is positioned at a maximum distance from the first brake disc 5 and does not actuate a parking-braking force, to a closed position, in which the at least one first pad is biased against the first brake disc 5 and applies a parking-braking force, and vice versa.

The second brake caliper 8 comprises:
a second brake disc 6;
at least one second pad positioned to face the second brake disc 6;
at least one second actuator 3, configured to apply and release a second braking force F2 on the at least one second pad so as to move the at least one second pad from an open position, in which the at least one second pad is positioned at a maximum distance from the second brake disc 6 and does not actuate a braking force, to a closed position, in which the at least one second pad is biased against the second brake disc 6 and applies a parking-braking force, and vice versa.

The braking system 1 further comprises:
an electronic processing unit 4, configured to control the actuation of the at least one first actuator 2 and the at least one second actuator 3;
detection means, operatively connected to the electronic processing unit 4, configured to detect, either directly or indirectly, the value of the first braking force F1 actuated by the at least one first actuator 2 on the at least one first pad, and to detect, either directly or indirectly, the value of the second braking force F2 actuated by the at least one second actuator 3 on the at least one second pad.

Furthermore, the braking system 1 is configured to deactivate the parking-braking force by performing a method as previously described, and not repeated here to avoid redundancy.

Advantageously, a braking system 1 thus configured allows minimizing the time interval which elapses from the instant in which the deactivation of the parking-braking is required to a zero force time instant to in which the vehicle is ready to restart, i.e., in which the parking-braking force actuated by the braking system is reduced to zero.

Advantageously, the first brake caliper 7 and the second brake caliper 8 are fixed or floating brake calipers.

According to an embodiment, the detection means comprise an angular position detector, preferably an encoder, configured to detect the angular position of the at least one first actuator 2 and/or the at least one second actuator 3.

Alternatively or additionally, the detection means comprises a current detector, preferably an ammeter, configured to detect the value of a supply current i1, i2 which supplies either the at least one first actuator 2 or the at least one second actuator 3.

The electronic processing unit 4 comprises a calculator configured to calculate the value of the first braking force F1 and/or the second braking force F2 based on the angular position of the at least one first actuator 2 or the at least one second actuator 3, respectively.

Alternatively or additionally, calculator is the configured to calculate the value of the first braking force F1 and/or the second braking force F2 based on the value of the supply current i1, i2 supplying the at least one first actuator 2 or the at least one second actuator 3, respectively.

According to an embodiment, the system 1 comprises an actuating device operatively connected to the electronic processing unit 4.

Furthermore, the electronic processing unit 4 is configured to actuate the at least one first actuator 2 so as to release the first braking force F1 and reduce the value of the first braking force F1, is actuated upon the reception, by the electronic processing unit 4, of a parking-braking force deactivation request signal.

The parking-braking force deactivation request signal is sent by the actuating device upon actuation of said actuating device.

The actuating device is actuatable by a user.

Advantageously, the actuating device is positionable in the passenger compartment of the vehicle close to the position occupied by the user.

The actuating device can be, by way of example, an appropriate button, an ignition key, a gear shift actuator, an acceleration pedal or different pedal, or a device connected to automatic functions managed by the electronic processing unit 4 or an appropriate electronic processing unit.

According to an embodiment, the braking system 1 comprises a signaling device operatively connected to the electronic processing unit 4.

Furthermore, the electronic processing unit 4 is configured to send a parking-braking force deactivation signal to the signaling device.

The parking-braking force deactivation signal is viewable by a user by means of the signaling device.

The signaling device can be, for example, a warning light, or a digital screen positioned inside the passenger compartment of the vehicle close to the position occupied by the user.

According to an embodiment, the first brake caliper 7 comprises:
a pair of first pads positioned to be opposite to the first brake disc 5;
at least one pair of first actuators 2, configured to apply and release a first braking force F1 on the pair of first pads, so as to move the pair of first pads from an open position, in which both first pads are positioned at a maximum distance from the first brake disc 5 and do not actuate a parking-braking force, to a closed position, in which both first pads are biased against the first brake disc 5 and actuate a parking-braking force, and vice versa.

Furthermore, the second brake caliper 8 comprises:
a pair of second pads positioned to be opposite to the second brake disc 6;
at least one pair of second actuators 3, configured to apply and release a second braking force F2 on the pair of second pads, so as to move the pair of second pads from an open position, in which both second pads are positioned at a maximum distance from the second brake disc 6 and do not actuate a parking-braking force, to a closed position, in which both second pads are biased against the second brake disc 6 and actuate a parking-braking force, and vice versa.

Obviously, those skilled in the art will be able to make changes or adaptations to the present invention, without however departing from the scope of the following claims.

### LIST OF REFERENCE SIGNS

1. Braking system
2. First actuator
3. Second actuator
4. Electronic processing unit
5. First brake disc
6. Second brake disc
7. First brake caliper
8. Second brake caliper
F1. First braking force
F2. Second braking force
i1. First supply current
i2. Second supply current
t0. Zero force time instant
t1. First time instant
t2. Second time instant
t3. Third time instant

1-12. (canceled)

13. A method of controlling a braking system of a vehicle for deactivating a parking-braking force actuated by the braking system, the braking system comprising:
a first brake caliper comprising:
a first brake disc;
at least one first pad facing the first brake disc;
at least one first actuator configured to apply and release a first braking force on the at least one first pad, so as to move the at least one first pad from an open position, in which the at least one first pad is positioned at a maximum distance from the first brake disc and does not actuate the parking-braking force, to a closed position in which the at least one first pad is biased against the first brake disc and applies the parking-braking force, and vice versa;
a second brake caliper comprising:
a second brake disc;
at least one second pad facing the second brake disc;
at least one second actuator configured to apply and release a second braking force on the at least one second pad so as to move the at least one second pad from an open position, in which the at least one second pad is positioned at a maximum distance from the second brake disc and does not actuate the parking-braking force, to a closed position in which the at least one second pad is biased against the second brake disc and applies the parking-braking force, and vice versa;
an electronic processing unit configured to control an actuation of the at least one first actuator of the first brake caliper and the at least one second actuator of the second brake caliper;
detection means, operatively connected to the electronic processing unit, configured to detect, either directly or indirectly, a value of the first braking force actuated by the at least one first actuator on the at least one first pad, and to detect, either directly or indirectly, a value of the second braking force actuated by the at least one second actuator on the at least one second pad,
the method comprising steps of:
actuating, by the electronic processing unit, the at least one first actuator of the first brake caliper so as to release the first braking force and reduce the value of the first braking force;
detecting, by the detection means, the value of the first braking force during the actuation of the at least one first actuator;
at a first instant of time in which it is detected that the first braking force is reduced to a value substantially equal to zero, stopping the at least one first actuator and actuating the at least one second actuator, by the electronic processing unit, so as to release the second braking force and reduce the value of the second braking force; and
reducing the value of the second braking force to a value substantially equal to zero.

14. The method of claim 13, comprising, after the step of stopping the at least one first actuator and actuating the at least one second actuator, by the electronic processing unit, so as to release the second braking force and reduce the value of the second braking force, steps of:
detecting the value of the second braking force during the actuation of the at least one second actuator by the detection means;
in an instant in which it is detected that the second braking force is reduced to a value substantially equal to zero, continuing the actuation of the at least one second actuator so as to separate the at least one second pad from the second brake disc and move the at least one second pad towards the open position;
detecting a position of the at least one second pad, either directly or indirectly, during the actuation of the at least one second pad by the detection means;
at a second instant of time in which it is detected that the at least one second pad is positioned substantially in the open position, stopping the at least one second actuator and actuating the at least one first actuator, by the electronic processing unit, so as to separate the at least one first pad from the first brake disc and move the at least one first pad towards the open position;
and optionally:
detecting a position of the at least one first pad, either directly or indirectly, during the actuation of the at least one first pad by the detection means; and
stopping the at least one first actuator at a third time instant in which it is detected that the at least one first pad is positioned substantially in the open position.

15. The method of claim 13, comprising, after the step of stopping the at least one first actuator and actuating the at least one second actuator, by the electronic processing unit, so as to release the second braking force and reduce the value of the second braking force, steps of:
detecting the value of the second braking force during the actuation of at least one second pad by the detection means;
in an instant in which it is detected that the second braking force is reduced to a value substantially equal to zero, stopping the actuation of the at least one second actuator to actuate the at least one first actuator, by the electronic processing unit so as to separate the at least one first pad from the first brake disc and move the at least one first brake pad towards the open position;
detecting a position of the at least one first pad, either directly or indirectly, during the actuation of the at least one first pad by the detection means;
in an instant in which it is detected that the at least one first pad is positioned substantially in the open position, stopping the at least one first actuator and actuating the at least one second actuator, by the electronic processing unit, so as to separate the at least one second pad from the second brake disc and move the at least one second pad towards the open position;
and optionally:
detecting a position of the at least one second pad, either directly or indirectly, during the actuation of the at least one second pad by the detection means; and
stopping the at least one second actuator in an instant in which it is detected that the at least one second pad is positioned substantially in the open position.

16. The method of claim 13, wherein the step of detecting, by the detection means, the value of the first braking force comprises:
detecting an angular position of the at least one first actuator by the detection means; and
calculating, by the electronic processing unit, the value of the first braking force based on the angular position of at least one first actuator;
or
detecting a value of a first supply current supplying the at least one first actuator; and
calculating, by the electronic processing unit, the value of the first braking force based on the value of the first supply current supplying the at least one first actuator.

17. The method of claim 13, wherein the step of detecting, by the detection means, the value of the second braking force comprises:
detecting an angular position of the at least one second actuator by the detection means; and
calculating, by the electronic processing unit, the value of the second braking force based on the angular position of the at least one second actuator;
or
detecting a value of a second supply current supplying the at least one second actuator; and
calculating, by the electronic processing unit, the value of the second braking force based on the value of the second supply current supplying the at least one second actuator.

18. The method of claim 14, wherein the step of directly or indirectly detecting the position of the at least one second pad by the detection means comprises:
detecting an elapsing of a predetermined time interval, starting from the instant in which it is detected that the second braking force is reduced to a value substantially equal to zero, by the detection means; and
associating, by the electronic processing unit, a positioning of the at least one second pad in the open position at the end of the predetermined time interval,
or:
detecting an angular position of the at least one second actuator by the detection means; and
associating, by the electronic processing unit, the positioning of the at least one second pad in the open position with a predetermined angular position of the at least one second actuator.

19. The method of claim 18, wherein the step of detecting the position of the at least one first pad, either directly or indirectly, during the actuation of the at least one first pad by the detection means comprises:
detecting, by the detection means, an elapsing of a predetermined time interval, starting from an instant in which the at least one second actuator is stopped;
associating, by the electronic processing unit, a positioning of the at least one first pad in the open position at the end of the predetermined time interval,
or:
detecting an angular position of the at least one first actuator by the detection means; and
associating, by the electronic processing unit, the positioning of the at least one first pad in the open position with a predetermined angular position of the at least one first actuator.

20. The method of claim 13, wherein the step of actuating, by the electronic processing unit, the at least one first actuator so as to release the first braking force and reduce the value of the first braking force, is actuated upon reception of a parking-braking force deactivation request signal by the electronic processing unit,
wherein the parking-braking force deactivation request signal is sent by an actuating device operatively connected to the electronic processing unit, upon actuation of said actuating device, said actuating device being actuatable by a user.

21. The method of claim 14 comprising, after the step of stopping the at least one first actuator at the instant in which it is detected that the at least one first pad is positioned substantially in the open position, a step of:
sending, from the electronic processing unit to a signaling device operatively connected to the electronic processing unit, a parking-braking force deactivation signal, wherein the parking-braking force deactivation signal is optionally viewable by a user by the signaling device.

22. The method of claim 13, wherein said first brake caliper comprises:
a pair of first pads positioned opposite to the first brake disc;
at least one pair of first actuators configured to apply and release the first braking force on the pair of first pads, so as to move the pair of first pads from an open position in which both first pads are positioned at a maximum distance from the first brake disc and do not actuate the parking-braking force, to a closed position in which both first pads are biased against the first brake disc and actuate the parking-braking force, and vice versa;
and wherein said second brake caliper comprises:
a pair of second pads positioned opposite the second brake disc;
at least one pair of second actuators configured to apply and release the second braking force on the pair of second pads, so as to move the pair of second pads from an open position, in which both second pads are positioned at a maximum distance from the second brake disc and do not actuate the parking-braking force, to a closed position in which both second pads are biased against the second brake disc and actuate the parking-braking force, and vice versa.

23. A braking system of a vehicle configured to activate and deactivate a parking-braking force, the braking system comprising:
a first brake caliper comprising:
a first brake disc;
at least one first pad facing the first brake disc;
at least one first actuator configured to apply and release a first braking force on the at least one first pad, so as to move the at least one first pad from an open position, in which the at least one first pad is positioned at a maximum distance from the first brake disc and does not actuate the parking-braking force, to a closed position in which the at least one first pad is biased against the first brake disc and applies the parking-braking force, and vice versa;
a second brake caliper comprising:
a second brake disc;
at least one second pad facing the second brake disc;
at least one second actuator configured to apply and release a second braking force on the at least one second pad so as to move the at least one second pad from an open position, in which the at least one second pad is positioned at a maximum distance from the second brake disc and does not actuate the parking-braking force, to a closed position in which the at least one second pad is biased against the second brake disc and applies the parking-braking force, and vice versa;
an electronic processing unit configured to control an actuation of the at least one first actuator of the first brake caliper and the at least one second actuator of the second brake caliper; and
detection means, operatively connected to the electronic processing unit, configured to detect, either directly or indirectly, a value of the first braking force actuated by the at least one first actuator on the at least one first pad, and to detect, either directly or indirectly, a value of the second braking force actuated by the at least one second actuator on the at least one second pad,
wherein the braking system is configured to disable the parking-braking force by performing the method of claim 13.

24. The system of claim 23, further comprising an actuating device operatively connected to the electronic processing unit,
wherein the electronic processing unit is configured to actuate the at least one first actuator so as to release the first braking force and reduce the value of the first braking force upon reception, by the electronic processing unit, of a parking-braking force deactivation request signal,
wherein the parking-braking force deactivation request signal is sent by the actuating device upon actuation of said actuating device, and
wherein said actuating device is actuatable by a user.

25. The system of claim 23, wherein the braking system comprises a signaling device operatively connected to the electronic processing unit,
wherein the electronic processing unit is configured to send a parking-braking force deactivation signal to the signaling device, and
wherein the parking-braking force deactivation signal is viewable by a user by means of the signaling device.

26. The braking system of claim 23, wherein the first brake caliper comprises:
a pair of first pads positioned opposite to the first brake disc; and
at least one pair of first actuators configured to apply and release the first braking force on the pair of first pads, so as to move the pair of first pads from an open position in which both first pads are positioned at a maximum distance from the first brake disc and do not actuate the parking-braking force, to a closed position in which both first pads are biased against the first brake disc and actuate the parking-braking force, and vice versa;
and wherein said second brake caliper comprises:
a pair of second pads positioned opposite the second brake disc; and
at least one pair of second actuators configured to apply and release the second braking force on the pair of second pads, so as to move the pair of second pads from an open position, in which both second pads are positioned at a maximum distance from the second brake disc and do not actuate the parking-braking force, to a closed position in which both second pads are biased against the second brake disc and actuate the parking-braking force, and vice versa.
